(19) United States
(12) Patent Application Publication
(10) Pub. No.: US 2026/0087516 A1
(43) Pub. Date: Mar. 26, 2026

(54) SYSTEMS AND METHODS FOR CAPTURING AND PROCESSING SCREEN-RECORDED USER-SPECIFIC RECOMMENDED OUTPUT, DIGITAL ADVERTISEMENTS, AND AI-GENERATED MIXED MEDIA

(71) Applicants: Manh Nguyen, TORONTO (CA); Brice Gower, Richmond Hill (CA)

(72) Inventors: MANH NGUYEN, TORONTO (CA); BRICE GOWER, TORONTO (CA); AKASH CHOUDHARY, TORONTO (CA); ETHAN CABRAL, TORONTO (CA); MENGSHU NIE, NEW YORK CITY, NY (US); ANNE-MARIE MULUMBA, MONTREAL (CA); WASALA Rankothge Waruna Gayan KULAWANSHA, Whitby (CA); JOSEPH ALBI, TORONTO (CA); SAACHI BAGDE, MISSISSAUGA (CA); HO SHING KWONG, TORONTO (CA); Kareem Rahaman, Toronto (CA); Akash Sidhu, Toronto (CA); Amir Ali Vahid Kassiri, Vaughan (CA)

(21) Appl. No.: 19/264,714

(22) Filed: Jul. 9, 2025

Related U.S. Application Data
(60) Provisional application No. 63/668,780, filed on Jul. 9, 2024.

(51) Int. Cl. G06Q 30/0242; G06F 21/62; G06Q 30/0201

(52) U.S. Cl. CPC G06Q 30/0245; G06F 21/6254; G06Q 30/0201

(57) ABSTRACT

A system and method for analyzing screen-recorded personalized digital content using on-device computer vision and generative AI. A user captures content from a recommender system interface, such as screen activity or browser-rendered content, optionally with concurrent voice commentary. On-device processing generates intermediate representations using CLIP-style embeddings, OCR text, and transcribed audio tokens, flagging advertisements, changes in content, diversity in content, and similarities in content. A compact generative AI model produces metadata summaries, which users may annotate with tags or comments. A composite metadata package is transmitted to a cloud system, while raw media is deleted. The invention enables privacy-preserving, bandwidth-efficient insight into recommender-based media and user feedback.

### BACKGROUND OF THE INVENTION

Digital media consumption is increasingly shaped by personalized recommender systems, generative AI content, and targeted advertisements. As a result, no two users encounter the same content online, even within the same platform or time period.

Traditional methods in marketing and consumer research such as survey panels, web analytics, or clickstream data-are no longer sufficient to capture this fragmented and hyper-personalized content environment. These approaches miss the actual visual and behavioral context presented to users.

Moreover, black-box algorithmic ecosystems of third party digital platforms limit transparency into what content is shown, when it is shown, to whom it is shown and why. This opacity impedes innovation in audience segmentation, public trust in algorithms, and emerging efforts in algorithmic accountability and content safety.

Researchers and marketers also lack access to first-party data that includes synchronized screen capture, user commentary, and semantic cues. This data is crucial for understanding content effects on mental health, political polarization, human culture, and purchasing behavior.

Accordingly, there is a need for privacy-respecting, on-device systems that capture, analyze, and transform personalized digital content into structured, shareable metadata-without transmitting raw recordings. This invention addresses that need.

### BRIEF SUMMARY OF THE INVENTION

The present invention relates generally to the fields of computer vision, artificial intelligence, marketing, and digital media analytics. More specifically, it pertains to systems and methods for performing on-device analysis of screen-recorded and DOM captured, personalized digital content-namely recommender system outputs, generative AI media, online shopping behaviour, and digital advertisements tied to user provided inputs-and generating structured metadata within an easy to consume data visualization environment for marketing, behavioral, mental health related, and political polarization, research and analysis in a privacy-preserving and bandwidth-efficient manner.

### BRIEF DESCRIPTION OF THE DRAWINGS

FIG. 1 is a block diagram of a system architecture for on-device analysis of screen-recorded and DOM-extracted personalized media content.

FIG. 2 is a flow diagram of an artificial intelligence processing pipeline for generating multimodal intermediate representations from video, DOM elements, and voice inputs.

FIG. 3 is a schematic diagram of a metadata generation and user feedback interface showing integration of generative AI outputs with user-provided annotations.

FIG. 4 is a flowchart of the privacy redaction and verification process, including secure upload of metadata and deletion of raw media from the user device.

FIG. 5 is a graphical representation of a visualization dashboard for exploring content clusters and consumer profiles using aggregated metadata.

### DETAILED DESCRIPTION OF THE DRAWINGS

The embodiments of the present invention will now be described with reference to the accompanying drawings. These embodiments are provided to enable those skilled in the art to make and use the invention and are not intended to limit the scope of the claims in any way.

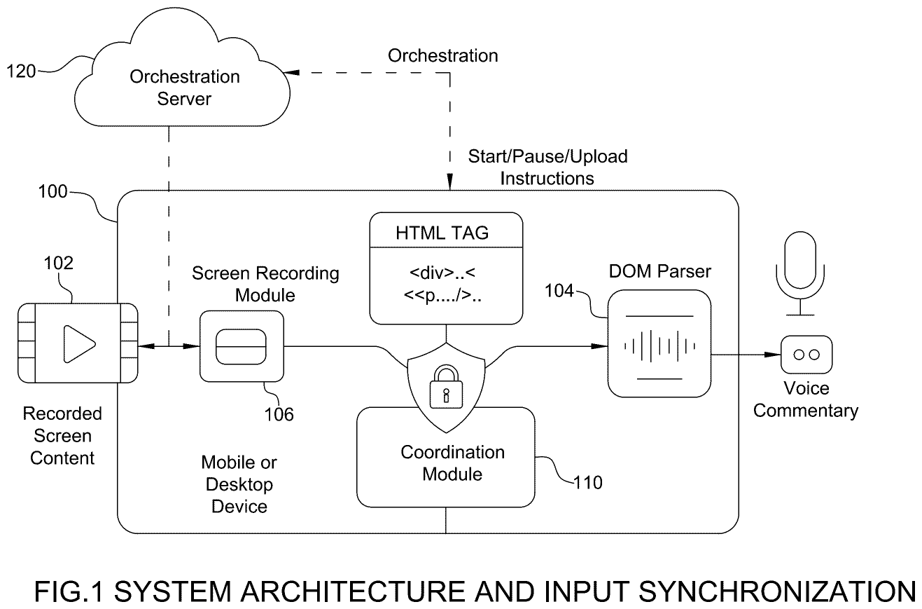

### FIG. 1—System Architecture and Input Synchronization

FIG. 1 illustrates the overall system architecture for on-device analysis of screen-recorded, user-personalized digital content. A user interacts with a computing device (100), such as a smartphone, tablet, or desktop. The device comprises:
a screen Recording Module (102) for Capturing Rendered Interfaces,
a DOM-parsing module (104) for extracting HTML content from browser-based sessions, a voice commentary capture module (106) for recording user-spoken input, and
a local processing unit (108) configured to run AI pipelines.

An orchestration server (120) communicates with the computing device via a secure connection. It transmits timing control signals that govern data capture, processing, and upload stages. A coordination module (110) aligns incoming streams-video frames, DOM elements, and audio waveforms-into a synchronized timeline for downstream analysis. No raw screen or audio data is transmitted off-device.

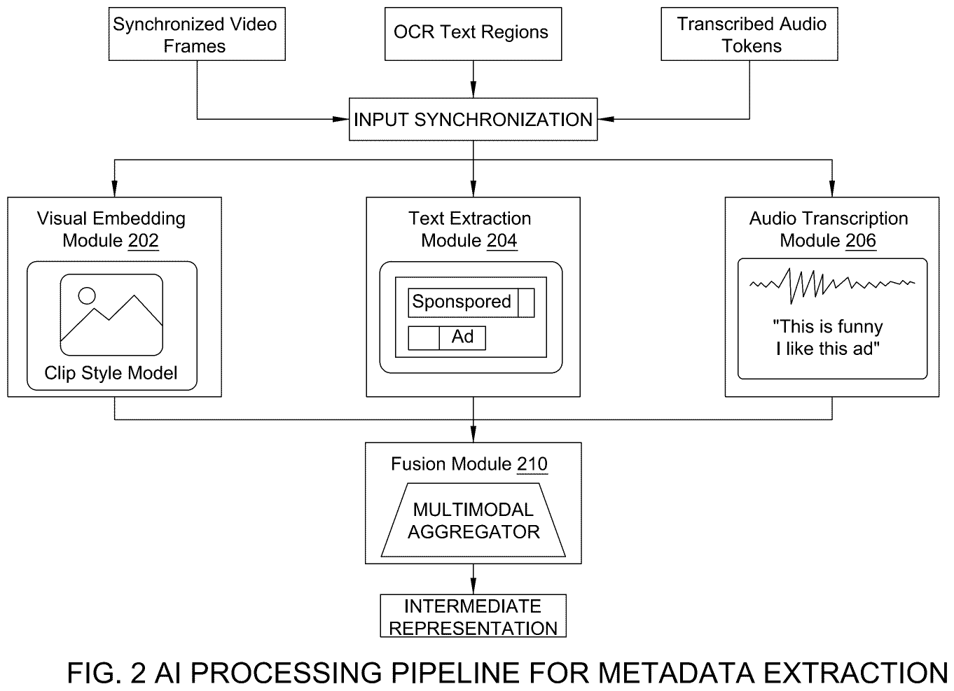

### FIG. 2—AI Processing Pipeline for Metadata Extraction

FIG. 2 depicts the AI-driven processing pipeline executed on-device. The synchronized session from FIG. 1 is passed through three core AI subsystems:
A CLIP-style model (202) generates visual-semantic embeddings from video frames,
An OCR engine (204) extracts structured text from video frames and DOM regions,
A transcription model (206), such as Whisper, converts speech into time-aligned text.

All extracted features are normalized and sent to a fusion module (210), which aggregates them into a unified intermediate representation. This representation supports multimodal alignment across vision, text, and speech, and serves as input for the generative metadata model.

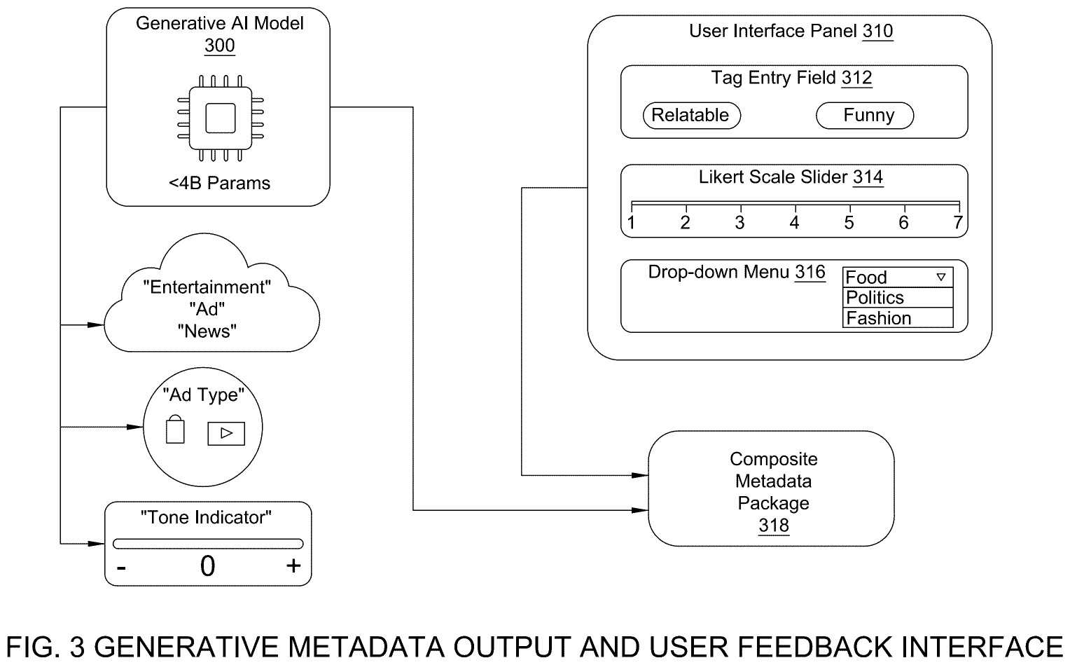

### FIG. 3—Generative Metadata Output and User Feedback Interface

FIG. 3 illustrates how structured metadata is generated and enriched. The intermediate representation (from FIG. 2) is processed by a local generative AI model (300) with <4 B parameters, producing:
inferred content labels (302), advertisement classification, topical descriptors, and
sentiment or tone indicators.

A user-facing interface (310) displays the generated metadata. The user may:
add tags (312), rate content using Likert scales (314), and
categorize the content using predefined or dynamic labels (316).

These user inputs are combined with system-generated data into a composite metadata package (318), which is retained locally for privacy processing.

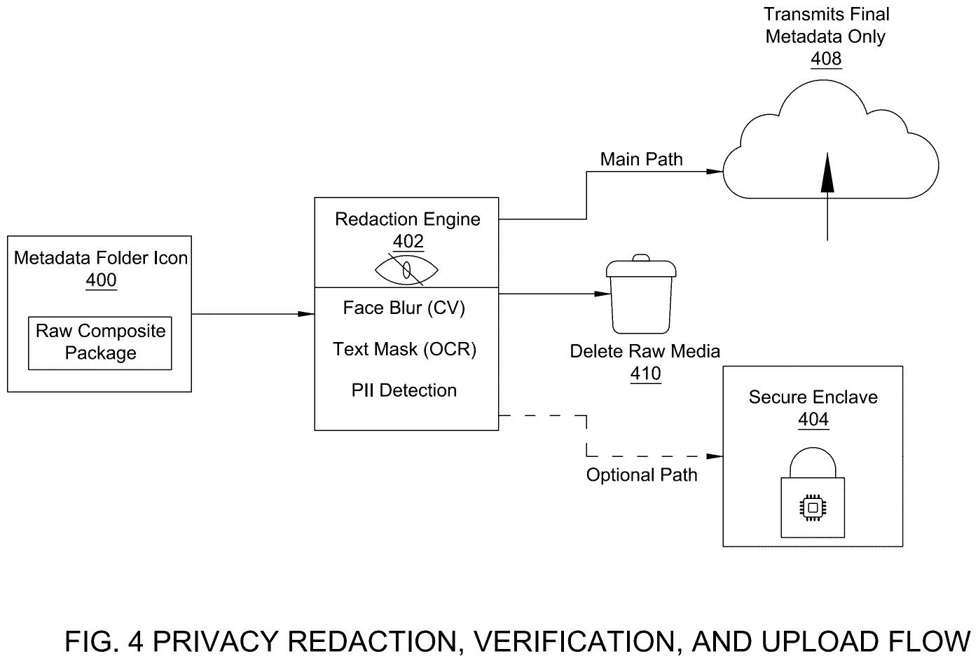

### FIG. 4—Privacy Redaction, Verification, and Upload Flow

FIG. 4 presents the privacy-preservation workflow. The composite metadata package from FIG. 3 is first passed through a redaction module (402) that uses OCR and CV models to identify and mask personally identifiable information (PII), such as names, profile pictures, or usernames.

Optionally, a secure enclave (404) performs cryptographic verification that all redaction criteria have been met. Once verified, the sanitized metadata (406)—along with an optional depersonalized video—is uploaded to a cloud analytics service (408). The system then irreversibly deletes raw audio and screen media from the device (410).

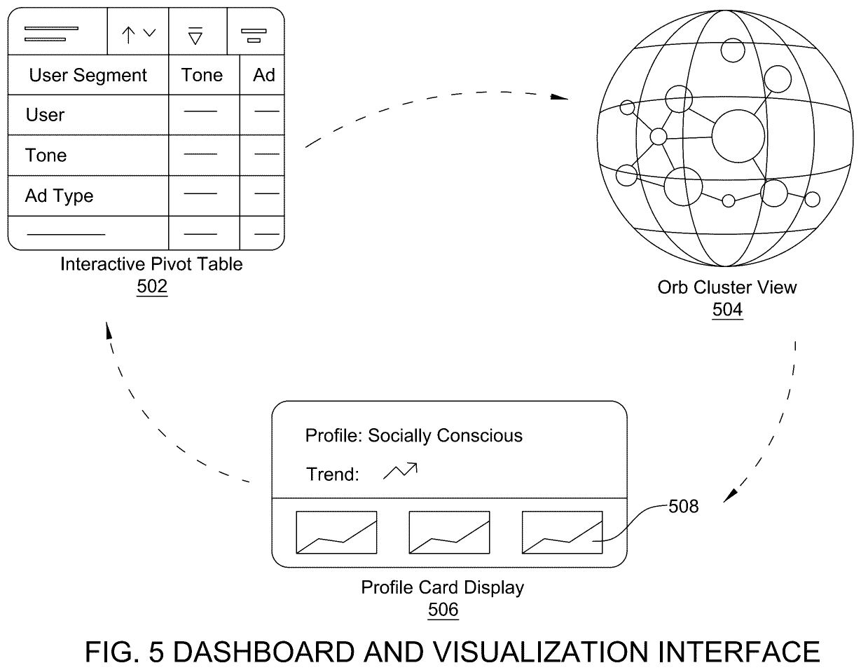

### FIG. 5—Dashboard and Visualization Interface

FIG. 5 shows a data visualization interface used for segment exploration and consumer analysis. It includes:
an interactive pivot table (502) summarizing aggregated metadata by user type, emotional response, or ad exposure,
a three-dimensional orb cluster network (504) showing similarity groupings of content or user profiles based on embedding proximity, and

a profile card view (506) that appears upon selection of a cluster. Each card displays:
a profile name,
a trend indicator (e.g., growth over time), anda scrollable preview (508) of representative content.

The dashboard allows researchers or analysts to visualize behavioral insights at both individual and group levels using dynamic filters and segmentation controls.

1. A computer-implemented method for analyzing and displaying personalized digital content, digital advertisements, online shopping behaviour, and AI generated mixed media related to a third-party recommender system, the method comprising:
(a) receiving, on a computing device, content presented via a visual user interface of a third-party recommender system and associated personalized media content, including digital advertisements and generative media, wherein the content comprises at least one of:
(i) a screen-recorded video depicting the rendered interface; or
(ii) document object model (DOM) elements extracted from a web browser;
(b) optionally recording, during step (a), audio commentary provided by the user during the screen recording session;
(c) executing, under orchestration-server control, a computer-vision pipeline to extract an intermediate representation comprising:
(i) image-text embeddings;
(ii) OCR-derived structured text regions; and
(iii) transcribed speech, aligned to video segments;
(d) generating, on the computing device, metadata describing the personalized content, the metadata including at least:
(i) a promotion-indicator flag set to TRUE when optical-character recognition detects any keyword selected from the group consisting of “Sponsored,” “AD,” “Promoted,” and “Shop” within a text region that overlaps the visual boundary of the media tile;
(ii) a diversity-indicator flag set to TRUE when an asset identifier of a current segment is absent from a rolling cache of asset identifiers extracted from a predetermined number of immediately preceding segments;
(iii) a similarity-indicator flag that is TRUE when, within a rolling window of N segments, a majority exhibit a cosine similarity ≥T₁ in a unified image-text embedding space;
(iv) a context-switch flag that is TRUE when a newly ingested segment diverges from a previous centroid by more than T₂ and at least M subsequent segments align more closely with a new centroid; and
(v) a recommender-system-output satisfaction indicator comprising, a self-reported representation score, a change-propensity score; and a comfort score, each supplied on a Likert scale;
(e) receiving user-supplied tags and Likert-scale scores;
(f) receiving, from the user via an interactive interface, one or more metadata tags associated with the content of the screen-recorded video or its AI-generated summary;
(g) merging metadata, tags, summaries, and scores into a composite metadata package;
(h) associating the user-supplied tags with the corresponding metadata generated in step (d), and integrating transcribed user commentary into the metadata structure;
(i) transmitting the metadata of step (f), and optionally the depersonalized video, to a cloud-based storage or analytics service;
(j) redacting PII, generating a verification indicator, and transmitting the package to a cloud-based service while deleting raw media;
(k) visualizing the metadata in a dashboard that groups segments by consumer-profile type, orders such groups by change, and renders a representative “For-You Page” preview responsive to a user selection of the group name;
wherein steps (b)-(h) are executed without transmitting raw video or unprocessed audio commentary, thereby preserving privacy and minimizing bandwidth usage.

2. The method of claim 1,
wherein advertisements include generative AI-based media or dynamically rendered formats.

3. The method of claim 1,
wherein advertisement regions are detected and segmented from screen-recorded or DOM-captured content using visual and text features.

4. The method of claim 1,
wherein personally identifiable visual and textual elements are automatically redacted using a computer vision model prior to step (g), and a verification indicator is generated.

5. The method of claim 1,
wherein the speech tokens are processed to infer emotional tone.

6. The method of claim 1,
wherein the orchestration server directs the computing device to initiate, pause, or resume any of steps (b)-(f).

7. The method of claim 1,
wherein the computing device operates in a DOM-only mode, without capturing screen video.

8. The method of claim 1, wherein steps (a)-(g) are executed within a third-party digital-survey platform rendered in a web browser.

9. A computing device comprising:
a processor and memory storing instructions that, when executed, cause the computing device to:
(i) receive a screen-recorded video or DOM elements of a third-party personalized recommender system interface;
(ii) optionally record audio commentary from a user;
(iii) extract an intermediate representation from the video comprising:
(a) joint visual-semantic embeddings;
(b) OCR-derived structured text data with bounding regions;
(c) transcribed audio tokens aligned to frame timestamps, including transcription of the user's recorded audio commentary;
(iv) apply an on-device generative AI model to generate metadata describing the screen-recorded content, the metadata including:
(a) the promotion-indicator flag, and
(b) the diversity-indicator score, and
(c) the similarity indicator score, and
(d) the context switch flag, and
(f) the recommender-system-output satisfaction score each defined as in claim 1(d)(i)-(v);
(v) receive one or more user-generated metadata tags via an interactive interface;
(vi) associate the user-generated tags, transcribed user commentary, and likert scores with the metadata generated in step (iv);
(vii) merge the tags, flags, scores, and summaries into a complete metapackage, and, optionally, a depersonalized version of the screen-recorded video to a remote service;
The system of claim 11, further comprising a privacy-dashboard module that displays (i) active research campaigns utilising a participant's data, (ii) campaign budget and duration, and (iii) a usage counter indicating how many campaigns currently reference the participant's metadata
wherein the computing device deletes the original user commentary audio recording after transcription and association.

10. The system of claim 9,
wherein the computing device transmits a verification indicator confirming redaction of personally identifiable information.

11. The system of claim 9,
wherein the processor uses quantized neural networks optimized for on-device inference using less than 2 GB RAM.

12. The system of claim 9,
wherein the metadata includes topic summaries and optional relevance scores for each video segment.

13. The system of claim 9,
wherein the generative AI model supports multimodal alignment across video, text, and audio inputs.

14. The system of claim 9,
further comprising a visual interface configured to render: (a) an interactive pivot table of aggregated metadata; and (b) a three-dimensional orb network clustered by similarity.

15. The system of claim 9,
wherein the pivot table and orb network are synchronised such that selecting a value in one view updates the other.

16. The system of claim 9,
wherein each orb represents either an individual user or a consumer profile type, with clustering determined by shared metadata or similarity embeddings.

17. The system of claim 9,
further comprising a consumer profile card view, wherein each card displays: (a) a profile name; (b) a growth trend indicator; and (c) a scrollable preview of representative content for that profile.

18. A non-transitory computer-readable medium storing instructions that, when executed by a processor of a computing device, cause the processor to:
(a) receive a screen-recorded video showing personalized digital content rendered by a third-party recommender system;
(b) optionally record user-provided voice commentary during the screen-recording session;
(c) process the video and any recorded audio to extract:
(i) image-text embeddings;
(ii) OCR-derived text regions;
(iii) speech transcripts, including voice commentary, aligned to video segments;
(d) apply an on-device AI model to generate textual metadata describing or classifying the recorded content, the metadata including:
(i) the promotion-indicator flag, and
(ii) the diversity-indicator score, each defined as in claim 1(d)(i)-(ii);
(e) receive user-supplied tags associated with the metadata from an application interface;
(f) combine the user tags and transcribed commentary with the generated metadata to form a composite metadata package;
(g) output the composite metadata for transmission to a network service or for local storage;
wherein the processor deletes any stored audio file recorded in step (b) after step (f) is complete.

19. The medium of claim 18, wherein the instructions further cause the processor to:
(a) perform product, company, publisher, or advertiser name extraction, sentiment analysis, or inferred user interest detection with metadata generation;
(b) include language confidence scores in the OCR-derived text, with support for multiple languages;
(c) segment the speech transcripts into speaker turns or utterances; and
(d) store user-supplied tags in association with the AI-generated metadata and link the tags to specific segments of the screen-recorded video.

20. The medium of claim 18, wherein the instructions further cause the processor to:
(a) transmit the composite metadata of step (f), and optionally the depersonalized video, to a cloud-based storage or analytics service;
(b) redact personally identifiable information (PII), generate a verification indicator, and transmit the package to a cloud-based service while deleting raw media;
(c) visualize data in a dashboard that (i) groups segments by consumer-profile type, (ii) orders such groups by change, and (iii) renders a representative “For-You Page” or “Explore Page” preview responsive to a user selection of the group name;
wherein the instructions of claim 18(a) through 18(g) are executed without transmitting raw video or unprocessed audio commentary to the cloud, thereby preserving privacy and minimizing bandwidth usage; and wherein the instructions optionally cause the processor to provide monetary compensation or rewards to the user based on participation, usage, or contribution of metadata.
